(19) United States
(12) Patent Application Publication
(10) Pub. No.: US 2004/0187247 A1
(43) Pub. Date: Sep. 30, 2004

(54) Wiper blade having fin

(75) Inventors: Naoki Torii, Toyohashi-city (JP); Toshiharu Aoyama, Toyohashi-city (JP); Shigeyuki Kobayashi, Kosai-city (JP); Yoshimasa Houjyo, Nishio-city (JP)

Correspondence Address: POSZ & BETHARDS, PLC, 11250 ROGER BACON DRIVE, SUITE 10, RESTON, VA, 20190, US

(73) Assignees: ASMO CO., LTD.; NIPPON WIPER BLADE CO., LTD.; TOKAI RIKI MFG. CO., LTD.

(21) Appl. No.: 10/808,435

(22) Filed: Mar. 25, 2004

(30) Foreign Application Priority Data
Mar. 27, 2003 (JP) 2003-87390

(51) Int. Cl. B60S 1/38

(52) U.S. Cl. 15/250.201; 15/250.44; 15/250.361

(57) ABSTRACT

A cover of a wiper blade for a vehicle includes a front surface wall and a rear surface wall, which are connected to each other to form a cap-shaped elongated body that has a base end opening at a base end thereof and that receives primary and yoke levers and backing plates, which are connected to a blade rubber. The front surface wall has a tilted outer surface that is tilted relative to a wiping surface to form a fin, which limits lifting of the wiper blade from the wiping surface when the vehicle is running.

### CROSS REFERENCE TO RELATED APPLICATION

This application is based on and incorporates herein by reference Japanese Patent Application No. 2003-87390 filed on Mar. 27, 2003.

### BACKGROUND OF THE INVENTION

1. Field of the Invention

The present invention relates to a wiper blade, which is used in a wiper system that wipes a wiping surface, such as a windshield glass surface of a vehicle.

2. Description of Related Art

In a vehicle wiper system, which wipes a wiping surface, such as a windshield glass surface of a vehicle, a tournament wiper blade (hereinafter referred to as a standard blade), which includes a blade rubber and a plurality of levers, is generally used. The blade rubber contacts and wipes the windshield glass surface. The levers hold the blade rubber and are interconnected to have a tournament design. Japanese Unexamined Patent Publication No. 2-303958 discloses one such standard blade, which has a spoiler fin secured to one of the levers to limit lifting of the standard wiper blade from the wiping surface by converting the wind applied to the running vehicle into a pressing force that presses the wiper blade against the wiping surface at the time of driving the vehicle at high speed.

However, since the fin is secured to the one of the levers, the pressing force generated by the wind applied to the running vehicle is spread over the blade rubber through the levers. Thus, a localized pressure is applied to predetermined portions of the blade rubber, which are held by the levers, so that it is difficult to uniformly distribute the pressure along the entire length of the blade rubber.

Furthermore, in cold locations where snow falls during the winter season, a winter blade is often used. Japanese Unexamined Patent publication No. 7-15465 discloses one winter blade, which has a hood that surrounds the blade rubber of the standard blade.

In general, when snow is accumulated in the spaces formed between the levers and is then frozen, rotatable movement of the levers is prohibited. However, in the above winter blade, since the hood covers the levers, it is possible to limit intrusion of snow into the spaces formed between the levers. Although the hood provides the above advantage, the hood blocks an airflow, which is generated along the windshield during the running of the vehicle, so that the airflow cannot pass through the spaces formed between the levers. This causes lifting of the wiper blade from the windshield. In order to limit the lifting of the wiper blade, one type of previously proposed winter blade has a spoiler fin, which is similar to the spoiler fin disclosed in Japanese Unexamined Patent Publication No. 2-303958 and is secured to one of the levers through an opening of the hood. Even in such a winter blade, the pressing force of the wind applied to the running vehicle is spread through the levers to cause application of localized force to predetermined portions of the blade rubber. As a result, it is difficult to uniformly distribute the pressure along the entire length of the blade rubber.

### SUMMARY OF THE INVENTION

The present invention addresses the above disadvantages. Thus, it is an objective of the present invention to provide a wiper blade, which can limit intrusion of snow into spaces formed between levers of the wiper blade and can also achieve effective wiping performance during running of a vehicle at high speed.

To achieve the objective of the present invention, there is provided a wiper blade for a wiper system that wipes a wiping surface. The wiper blade includes an elongated blade rubber, at least one backing plate, at least one holding lever and a cover member. The elongated blade rubber wipes the wiping surface. The at least one backing plate extends in a longitudinal direction of the blade rubber and is connected to the blade rubber. Each backing plate is curved in a direction generally perpendicular to the wiping surface and is made of a spring material, which has spring resiliency in the direction generally perpendicular to the wiping surface. At least one holding lever holds the blade rubber and the at least one backing plate. The cover member includes a front surface wall and a rear surface wall, which are connected to each other to form a cap-shaped elongated body that has a base end opening at a base end thereof and that receives the at least one holding lever and the at least one backing plate. The front surface wall has a tilted outer surface that is tilted relative to the wiping surface to form a fin.

### BRIEF DESCRIPTION OF THE DRAWINGS

The invention, together with additional objectives, features and advantages thereof, will be best understood from the following description, the appended claims and the accompanying drawings in which:

FIG. 1 is a plan view of a wiper blade according to an embodiment of the present invention;

FIG. 2 is a partially fragmented front view of the wiper blade;

FIG. 3 is a cross sectional view along line III-III in FIG. 2;

FIG. 4 is a cross sectional view along line IV-IV in FIG. 2;

FIG. 5 is a cross sectional view along line V-V in FIG. 2;

FIG. 6 is a cross sectional view along line VI-VI in FIG. 2;

FIG. 7 is a cross sectional view along line VII-VII in FIG. 2; and

FIG. 8 is a partially fragmented perspective view showing a main structure of the wiper blade of the present embodiment.

### DETAILED DESCRIPTION OF THE INVENTION

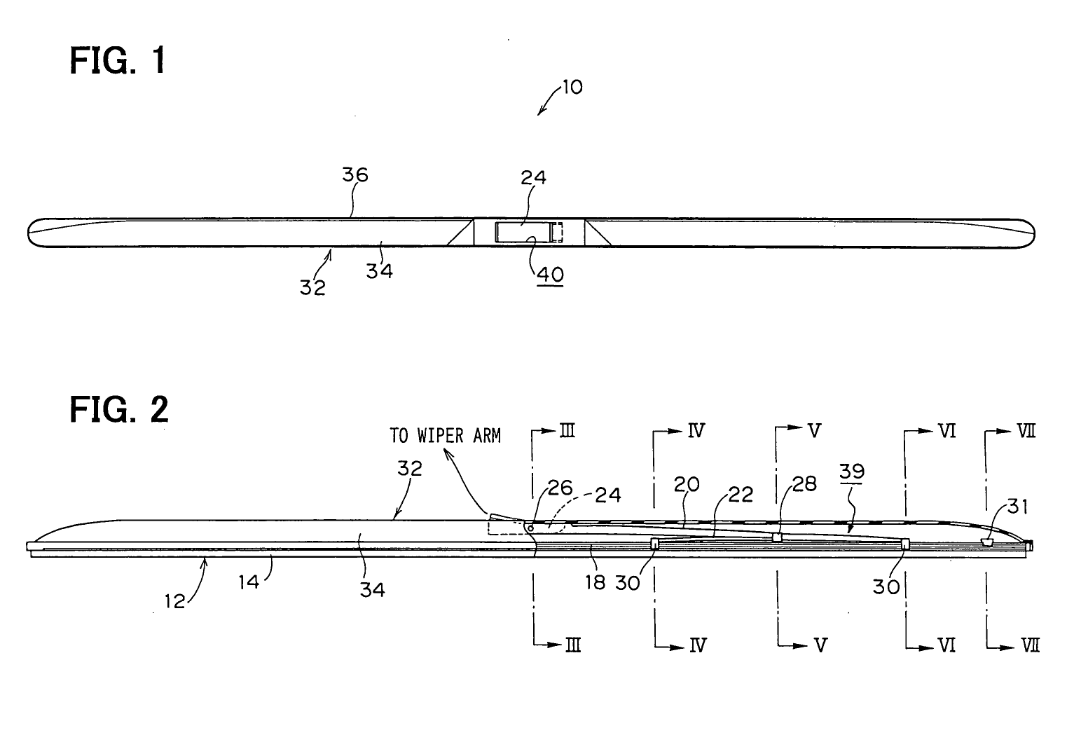

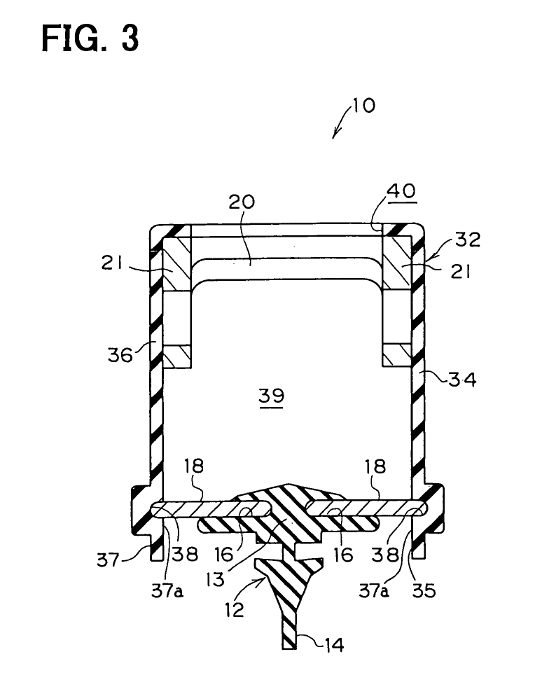

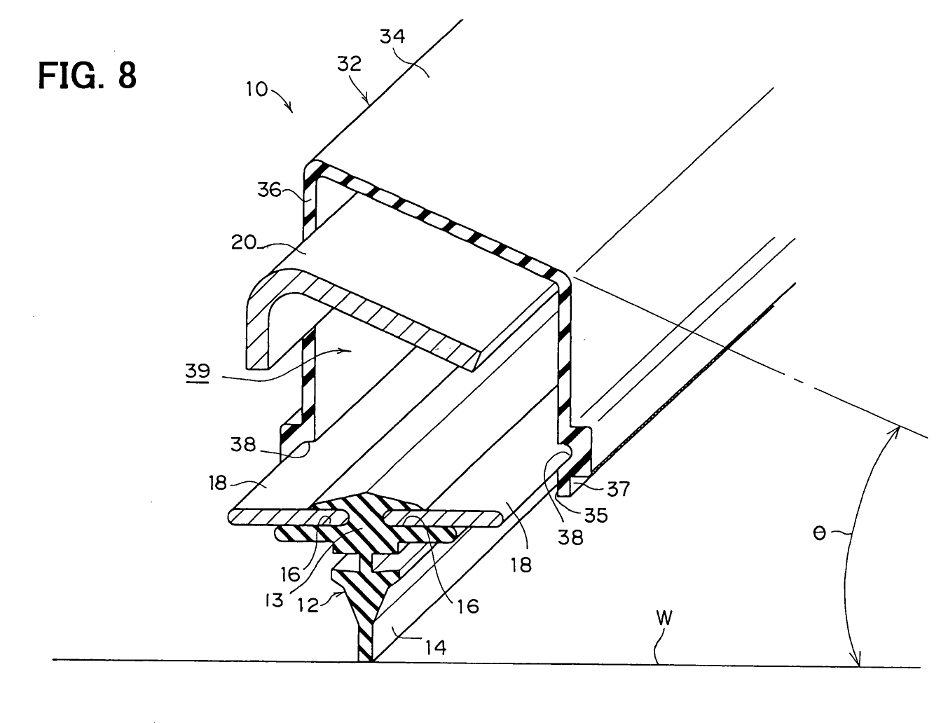

With reference to FIGS. 1-8, a wiper blade 10 of a wiper system according to an embodiment of the present invention includes a blade rubber 12. The blade rubber 12 is elongated and is made of a resilient material, such as a rubber material or an urethane elastomer material, which has a predetermined resiliency. The blade rubber 12 includes a base 13 and a wiping lip (also sometimes simply referred to as a wiping portion) 14. The wiping lip 14 extends from the base 13 toward a wiping surface (e.g., a windshield glass surface of the vehicle) W shown in FIGS. 3-8 and is tiltably supported by the base 13. The wiping lip 14 is elongated in a longitudinal direction of the blade rubber 12. When the wiping lip 14 contacts the wiping surface W, and the blade rubber 12 is reciprocally swung along the wiping surface W, the wiping surface W is wiped by the wiping lip 14.

With reference to FIGS. 3-8, two fitting grooves 16 are formed to extend in the longitudinal direction in left and right lateral sides, respectively, of the base 13 of the blade rubber 12, which are opposed to each other in a transverse direction of the blade rubber 12. Two backing plates 18 are fitted into the fitting grooves 16, respectively. Each backing plate 18 is elongated and is made of a spring plate material, which has spring resiliency in a direction generally perpendicular to the wiping surface W. In a natural unstressed state, the backing plate 18 is curved along the length of the backing plate 18. More specifically, the backing plate 18 is concavely curved in a direction away from the wiping surface W. When a lateral edge (peripheral edge) of each backing plate 18 is integrally fitted in the corresponding fitting groove 16 of the blade rubber 12 (base 13), a predetermined resiliency is provided to the blade rubber 12.

Furthermore, the wiper blade 10 includes a primary lever 20 and yoke levers 22. The primary lever 20 and the yoke levers 22 serve as holding levers of the present invention.

The primary lever 20 has a downcurved cross section, and an opening side of the downcuved cross section is oriented toward the wiping surface W. A connecting clip 24 is provided to a longitudinal center of the primary lever 20. The connecting clip 24 is formed into a block shape, which corresponds to a distal end holding portion of an undepicted wiper arm (arm piece). The connecting clip 24 is rotatably connected to the primary lever 20 by a rivet 26. When the distal end holding portion of the arm piece is connected to the connecting clip 24, the primary lever 20 is rotatably supported by the wiper arm.

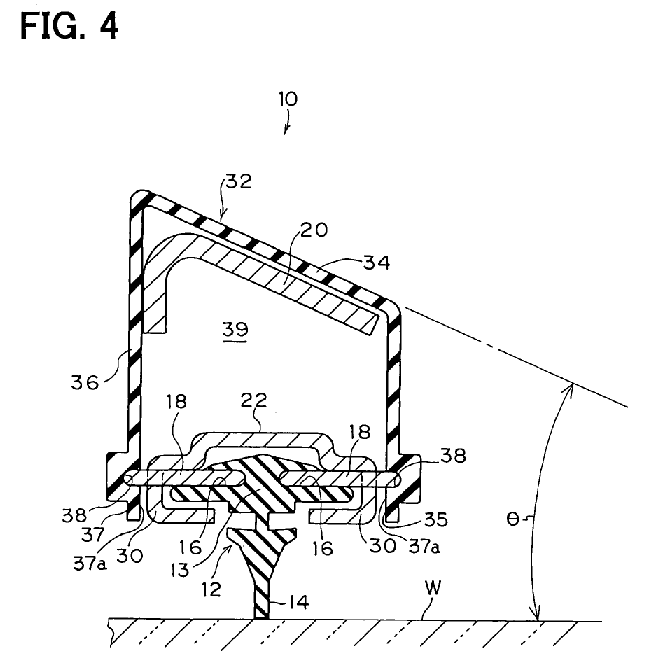

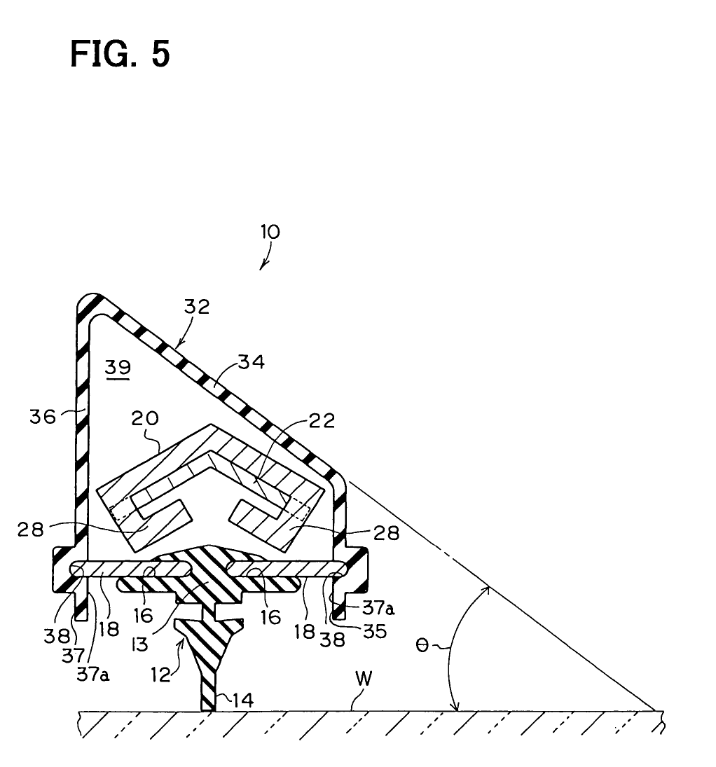

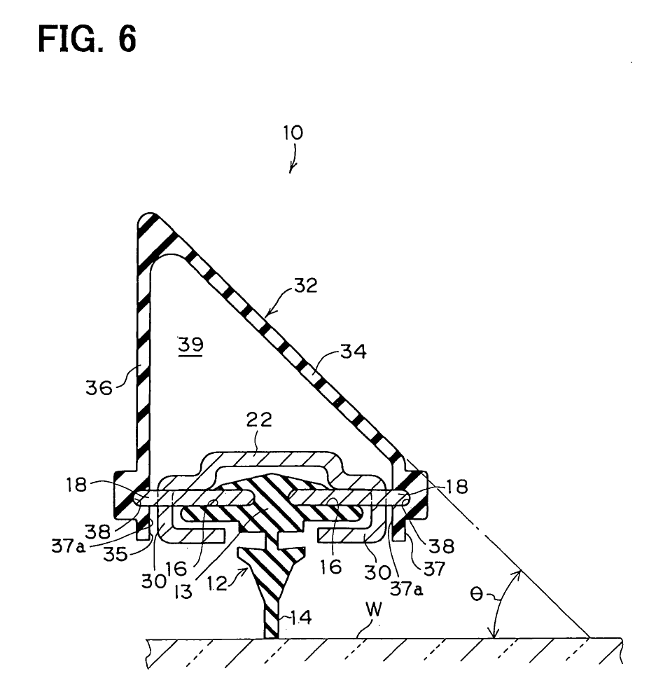

As shown in FIG. 5, a connecting portion 28, which has a horseshoe-shaped cross section at each lateral side thereof, is provided in each of opposed longitudinal ends of the primary lever 20. The yoke levers 22 are rotatably supported by the connecting portions 28, respectively. Furthermore, as shown in FIGS. 4 and 6, a holding portion 30, which has a horseshoe-shaped cross section at each lateral side thereof, is provided in each of opposed longitudinal ends of the yoke lever 22. The holding portions 30 hold the blade rubber 12 in cooperation with the backing plates 18. Thus, the wiper blade 10 has a two stage tournament wiper blade structure, which is achieved by the primary lever 20 and the yoke levers 22.

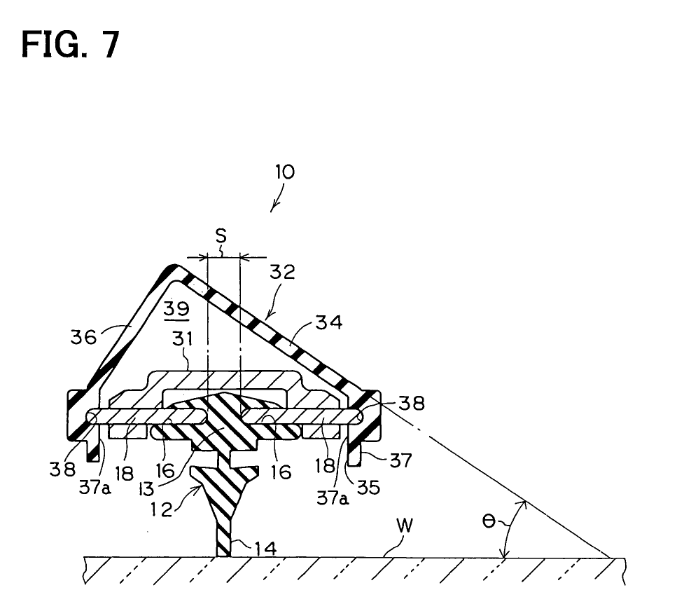

As shown in FIGS. 2 and 7, a bridge piece 31 is provided to each of the longitudinal ends of the blade rubber 12 and thereby of the backing plates 18. The bridge piece 31 transversely extends over the backing plates 18, which are provided to the opposed lateral sides of the blade rubber 12 (more specifically, in the fitting grooves 16). The bridge pieces 31 maintain a space S between the backing plates 18.

The wiper blade 10 further includes a cover 32, which serves as a cover member of the present invention.

The cover 32 is made of a rubber material or an elastomer material, which has a rubber hardness (Hs) in a range of 40-80 Hs. The cover 32 includes a front surface wall 34 and a rear surface wall 36, which are connected to each other to form a cap-shaped elongated body (or a bag-shaped elongated body) that has a base end opening 35 at a base end 37 thereof. A portion of an outer surface of the front surface wall 34 of the cover 32 is formed into a fin shape that is angled or tilted relative to the wiping surface W. The fin serves as a spoiler and effectively limits lifting of the wiper blade 10 from the wiping surface W when the vehicle is running at high speed. As shown in FIG. 3, a longitudinal center of the front surface wall 34 (i.e., a portion of the front surface wall 34 where the connecting clip 24 is located) has an inverted L-shaped cross section (i.e., having a partial upper wall).

As shown in FIGS. 4-8, a tilt angle θ of the tilted outer surface of the fin-shaped front surface wall 34 (the portions of the front surface wall 34 other than the longitudinal center of the front surface wall 34) is an acute angle relative to the wiping surface W and progressively increases from the longitudinal center of the front surface wall 34 toward each of longitudinal ends of the front surface wall 34.

For example, the tilt angle θ of the front surface wall 34 is set to be in a range of 20-80 degrees.

Furthermore, the cover 32 has recessed holding grooves 38, which are formed in inner lateral sides 37a of the base end 37 of the cover 32 to extend in a longitudinal direction of the cover 32. A receiving space 39 of the cover 32 receives the primary lever 20, the yoke levers 22 and the backing plates 18 when the cover 32 is applied from the top side of the primary lever 20, the yoke levers 22 and the backing plates 18. When the backing plates 18 are received in the holding grooves 38 of the cover 32, the cover 32 is directly connected to and is retained by the backing plates 18. In this way, the cover 32 not only covers the primary lever 20, the yoke levers 22 and the backing plates 18 from the top side thereof but also covers all the lateral sides (i.e., an entire lateral perimeter) of the base 13 of the blade rubber 12.

Furthermore, a top opening 40 is formed in a top of the cover 32 at the longitudinal center of the cover 32 (i.e., the portion that corresponds to the connecting clip 24) in such a manner that the cover 32 does not interfere with the connection of the connecting clip 24 with the wiper arm (arm piece). In other words, the cover 32 covers lateral surfaces of the connecting clip 24, which is connected with the wiper arm. More specifically, the tilt angle θ of the front surface wall 34 is progressively increased toward the longitudinal center of the cover 32. At the connecting clip 24, the front surface wall 34 and the rear surface wall 36 are parallel to each other and continuously cover side walls 21 of the connecting portion of the primary lever 20, to which the connecting clip 24 is connected.

Next, operation of the present embodiment will be described.

In the wiper blade 10, the elongated blade rubber 12 is supported by the backing plates 18 and is also held by the primary lever 20 and the yoke levers 22. Furthermore, the primary lever 20, the yoke levers 22 and the backing plates 18 are received in the single cover 32, which is formed into the cap-shaped elongated body. The backing plates 18 are fitted into the recessed holding grooves 38, which are formed in the inner lateral sides 37a of the base end 37 of the cover 32. The cover 32 covers all the lateral sides of the base 13 of the blade rubber 12. Thus, the receiving space 39 of the cover 32, which receives the primary lever 20, the yoke levers 22 and the backing plates 18, is closed by the base 13 of the blade rubber 12. As a result, at the time of snowing, adhesion (intrusion) of snow to the primary lever 20, the yoke levers 22 and the backing plates 18 is more effectively limited. Furthermore, at the time of driving the vehicle at high speed, wind pressure (air flow) applied to the running vehicle can be more effectively received by the cover 32, so that lifting of the wiper can be effectively limited.

Furthermore, the single cover 32 receives the connecting clip 24 of the primary lever 20, to which the wiper arm is connected. Also, the single cover 32 covers the side walls 21 of the connecting portion of the primary lever 20. As a result, an integral design of the wiper blade 10 is achieved to provide a good appearance. Furthermore, the number of components can be advantageously reduced with the above structure of the wiper blade 10.

In the wiper blade 10, the front surface wall 34 of the cover 32 is shaped into the fin shape that is tilted relative to the wiping surface W. Furthermore, the cover 32 is directly connected to the backing plates 18, which hold the blade rubber 12 along the length of the blade rubber 12. In the previously proposed wiper blade, the fin is connected to one of the levers (e.g., a lever similar to the primary lever 20 or the yoke lever 22), so that the localized pressure is applied to the predetermined portions of the blade rubber, which are held by the levers, and therefore it is difficult to uniformly distribute the pressure along the length of the blade rubber. However, unlike the previously proposed wiper blade, in the wiper blade 10 of the present embodiment, the backing plates 18, which hold the blade rubber 12 along the length of the blade rubber 12, are pressed toward the wiping surface W by the wind pressure received by the fin-shaped front surface wall 34 of the cover 32 at the time of driving the vehicle at high speed. Thus, the blade rubber 12 is also effectively pressed against the wiping surface W through the backing plates 18. Furthermore, the pressing force, which is caused by the wind pressure, is uniformly and continuously applied to the blade rubber 12 along the entire length of the backing plates 18, i.e., along the entire length of the blade rubber 12. In other words, distribution of the pressure applied to the blade rubber 12 at the time of contacting the blade rubber 12 with the wiping surface W becomes more uniform along the length of the blade rubber 12.

As a result, more effective wiping performance of the wiper blade 10 can be achieved at the time of driving the vehicle at high speed.

Furthermore, the tilt angle θ of the fin-shaped front surface wall 34 of the cover 32 is the acute angle relative to the wiping surface W and progressively increases from the longitudinal center of the front surface wall 34 toward each of the longitudinal ends of the front surface wall 34. Thus, an enough space for accommodating the primary lever 20 and the yoke levers 22 are provided inside the cover 32, and the wind pressure (airflow), which is generated at the time of driving the vehicle at high speed, is effectively received by the cover 32.

Also, in the wiper blade 10, the backing plates 18 are fitted into the recessed holding grooves 38, which are formed in the inner lateral sides 37a of the base end 37 of the cover 32, and the cover 32 covers all the lateral sides (i.e., the entire lateral perimeter) of the base 13 of the blade rubber 12. Thus, the cover 32 is always stably supported. In this way, the wind pressure (airflow), which is generated at the time of driving the vehicle at high speed, is effectively received by the fin-shaped cover 32 and is effectively converted into the pressing force for pressing the blade rubber 12 against the wiping surface W. In addition, the adhesion (intrusion) of the snow to the levers at the time of snowing can be further effectively limited.

The cover 32 is made of the rubber material or the elastomer material, which has the rubber hardness in the range of 40-80 Hs. Thus, the moldability (easiness of manufacturing) of the cover 32 is improved. Also, the flexibility (softness) of the cover 32 is ensured at the time of rotating or pivoting the primary lever 20 and the yoke levers 22. Furthermore, the appropriate fin-shape of the cover 32 for limiting the lifting of the blade rubber 12 from the wiping surface W can be maintained. Thus, the cover 32 can maintain the appropriate wiping performance of the wiper blade 10 and can effectively receive the wind pressure (airflow) at the time of driving the vehicle at high speed.

Furthermore, the recessed holding grooves 38 are formed in the inner lateral sides 37a of the base end 37 of the cover 32, so that there is no need to further process or change other components, such as the backing plates 18, to connect the cover 32 to the rest of the wiper blade 10. As a result, the manufacturing costs of the wiper blade 10 can be minimized, and the assembly of the wiper blade 10 is eased.

Furthermore, in the wiper blade 10, the primary lever 20 and the yoke levers 22, which are connected to have the two stage tournament wiper blade structure, hold the blade rubber 12 and the backing plates 18. Thus, the lifting of the blade rubber 12 of the wiper blade 10 at the time of driving the vehicle at high speed can be effectively limited, and the blade rubber 12 can be flexed to effectively conform with the shape of the wiping surface (curved surface) W at the time of driving the vehicle at normal speed.

As described above, the wiper blade 10 can limit the intrusion and freezing of snow or the like at the levers at the cold locations and can ensure the appropriate wiping performance at the time of driving the vehicle at high speed. That is, the user (driver) does not need to select and change one of the standard blade and the winter blade to the other one based on the driving environment of the vehicle and can enjoy the appropriate wiping performance for all seasons.

In the above embodiment, the two stage tournament structure, in which the blade rubber 12 and the backing plates 18 are held by the primary lever 20 and the yoke levers 22, is used. Alternatively, a three stage tournament structure, which further includes a secondary lever(s) in addition to the primary lever 20 and the yoke levers 22, can be used. Furthermore, the yoke levers 22 can be eliminated to hold the blade rubber 12 and the backing plates 18 by the remaining single lever.

In the above embodiment, the cover 32 is installed when the backing plates 18 are fitted into the holding grooves 38, which are formed in the inner lateral sides 37a of the base end 37 of the cover 32. Furthermore, adhesive can be applied to the cover 32 to more securely connect the cover 32 to the backing plates 18 and to limit intrusion of water or the like into the receiving space 39.

In the above embodiment, the two separate backing plates 18 are fitted into the fitting grooves 16, which are provided in the left and right lateral sides, respectively, of the base 13 of the blade rubber 12. Alternatively, the two backing plates 18 can be replaced with a single backing plate, which is made of a spring metal plate material and is formed into a rail shape.

Additional advantages and modifications will readily occur to those skilled in the art. The invention in its broader terms is therefore not limited to the specific details, representative apparatus, and illustrative examples shown and described.

What is claimed is:

1. A wiper blade for a wiper system that wipes a wiping surface, the wiper blade comprising:
an elongated blade rubber that wipes the wiping surface;
at least one backing plate that extends in a longitudinal direction of the blade rubber and is connected to the blade rubber, wherein each backing plate is curved in a direction generally perpendicular to the wiping surface and is made of a spring material, which has spring resiliency in the direction generally perpendicular to the wiping surface;
at least one holding lever that holds the blade rubber and the at least one backing plate; and
a cover member that includes a front surface wall and a rear surface wall, which are connected to each other to form a cap-shaped elongated body that has a base end opening at a base end thereof and that receives the at least one holding lever and the at least one backing plate, wherein the front surface wall has a tilted outer surface that is tilted relative to the wiping surface to form a fin.

2. The wiper blade according to claim 1, wherein the cover member is directly secured to the at least one backing plate.

3. The wiper blade according to claim 2, wherein the base end of the cover member is directly secured to a peripheral edge of each of the at least one backing plate.

4. The wiper blade according to claim 3, wherein:
the base end of the cover member includes at least one recessed holding groove; and
the peripheral edge of each of the at least one backing plate is received in a corresponding one of the at least one recessed holding groove.

5. The wiper blade according to claim 4, wherein:
the at least one backing plate includes two backing plates;
the at least one recessed holding groove of the base end of the cover member includes two recessed holding grooves; and
the two backing plates are received in the two recessed holding grooves, respectively.

6. The wiper blade according to claim 3, wherein:
the blade rubber includes:
a wiping lip that directly contacts and wipes the wiping surface; and
a base that tiltably supports the wiping lip and holds the at least one backing plate; and
the cover member covers an entire lateral perimeter of the base of the blade rubber.

7. The wiper blade according to claim 1, further comprising a connecting clip that is connected to a corresponding wiper arm of the wiper system and is also connected to the at least one holding lever, wherein the cover member is made as a single member and receives the connecting clip in such a manner that the cover member covers a lateral surface of the connecting clip.

8. The wiper blade according to claim 1, wherein:
a tilt angle of the tilted outer surface of the front surface wall of the cover member, which forms the fin, is an acute angle with respect to the wiping surface; and
the tilt angle of tilted outer surface of the front surface wall progressively increases from a longitudinal center of the front surface wall toward each of opposed longitudinal ends of the front wall surface.

9. The wiper blade according to claim 1, wherein the cover member is made of one of a rubber material and an elastomer material and has a rubber hardness in a range of 40-80 Hs.

10. The wiper blade according to claim 9, wherein the cover member has a relatively thin wall thickness that maintains a tilt of the tilted outer surface of the front surface wall of the cover member, which forms the fin.

11. The wiper blade according to claim 1, wherein the at least one holding lever includes at least two holding levers, which are rotatably connected to each other.

12. The wiper blade according to claim 1, wherein:
the wiper blade is for a vehicle; and
the fin, which is made by the front surface wall, limits lifting of the wiper blade from the wiping surface when the vehicle is running.
